(19) United States
(12) Patent Application Publication
(10) Pub. No.: US 2005/0236778 A1
(43) Pub. Date: Oct. 27, 2005

(54) SEALING SYSTEM AND METHOD OF DETERMINING SEAL INTEGRITY

(75) Inventor: David J. Jupp, Calgary (CA)

Correspondence Address: SEAN W. GOODWIN, 237- 8TH AVE. S.E., SUITE 360, THE BURNS BUILDING, CALGARY, AB, T2G 5C3, CA

(73) Assignee: DYNETEK INDUSTRIES LTD., Calgary (CA)

(21) Appl. No.: 10/907,899

(22) Filed: Apr. 20, 2005

Related U.S. Application Data
(60) Provisional application No. 60/564,605, filed on Apr. 23, 2004.

(51) Int. Cl. F16J 15/02

(52) U.S. Cl. 277/312

(57) ABSTRACT

A sealing system for a high pressure fuel cylinder has an inner seal and an outer seal sealing an insert into a boss of the cylinder. Permeation rates as a result of the differential pressures across the seals are balanced across both the inner and outer seals to maintain a constant pressure in an intermediate space between the seals. Permeation is balanced by selecting suitable seal materials or by seal geometry or by providing a pressure relief device to the intermediate space to release excess pressure built up in the intermediate space beyond a desired intermediate pressure. Maintaining the intermediate pressure lower than the cylinder pressure and higher than atmospheric pressure results in lower pressure differentials across the seals, extending the seal life. A pressure switch or gauge is provided to monitor the pressure in the intermediate space. Changes in the pressure are indicative of a leak in one or both of the seals.

### CROSS REFERENCE TO RELATED APPLICATION

This application is a regular application claiming priority of U.S. Provisional Patent application Ser. No. 60/564,605 filed on Apr. 23, 2004, the entirety of which is incorporated herein by reference.

### FIELD OF THE INVENTION

Embodiments of the invention relate to sealing systems for pressure vessels and more particularly, to sealing systems for high pressure fuel cylinders and additionally, incorporating means for maintaining and monitoring seal integrity.

### BACKGROUND OF THE INVENTION

High pressure cylinders are known typically for carrying and supplying alternative fuels to vehicles such as compressed natural gas (CNG) vehicles and for hydrogen fuel cells. Due to the rigid safety requirements for such vessels, it is desirable to provide systems for sealing the boss or neck of the vessel that are robust and capable of maintaining the high pressure in the cylinders without fear of leaking.

Typically, conventional cylinders are sealed at an outer aspect of the boss using a face seal to provide sealing between an insert, such as a plug or a valve assembly, and the cylinder. The seal is rated to be able to contain at least the maximum pressure in the cylinder. Should the seal fail however, the contents of the vessel would be vented to atmosphere causing a loss of fuel from the cylinder and creating a combustion hazard, particularly if the vehicle is in an enclosed structure such as a garage. Failure of the seal is typically without warning and may result in a situation where a vehicle is stranded without sufficient fuel. Most often the operator is unaware of such a leak or failure of the seal until after a significant portion of the fuel within the cylinder has already escaped.

In an incident reported in the media, Toyota recalled a number of fuel cell vehicles as a result of leaking. Applicant believes that it was determined to be a leak at the valve-cylinder interface and when examined resulted due to failure of an O-ring.

Conventional seals used in high pressure fuel cylinders are subjected to large pressure differentials across the seal between the high pressure interior of the cylinder, as high as 700 bar (10,000 psi) for hydrogen storage cylinders, and atmosphere. The high pressure differential acts to reduce the life of the seal, despite using highly effective sealing materials.

The automotive industry has attempted to provide more reliable sealing by utilizing different seal materials, seal types and seal gland configurations. Further, tapered threads combined with sealing paste or tape has been used to prevent leaking however, Applicant believes this induces additional circumferential stress in the cylinder neck.

Ideally, a sealing system for high pressure fuel cylinders is capable of withstanding large pressure differentials for extended lifetimes without need for frequent replacement and more preferably is equipped with a means for detecting seal failure before the contents of the cylinder are vented.

### SUMMARY OF THE INVENTION

In one embodiment a unique apparatus, method and system for sealing a high pressure from a lower pressure, such as a high pressure fuel cylinder from atmospheric pressure, utilizes an inner seal spaced from an outer seal by an intermediate space. An intermediate pressure is maintained in the intermediate space to reduce the pressure differential across both the inner seal and the outer seal and thus extend seal life.

Typically, the intermediate space is formed about an insert fit within a boss of the high pressure fuel cylinders and the inner and outer seals seal between the insert and the cylinder boss.

In another embodiment a means for monitoring the intermediate pressure is fluidly connected to the intermediate space to permit detection of changes in the intermediate pressure, which are indicative of a leak in either or both the inner and outer seal.

Thus, in one broad aspect of embodiments of the invention a method for sealing a fluid at a first high pressure from a second lower pressure comprises: providing an inner seal capable of sealing the fluid at the first high pressure; providing an outer seal capable of sealing the fluid at the first high pressure, the outer seal being spaced from the inner seal for forming an intermediate space therebetween, the intermediate space having an intermediate pressure being lower than the first high pressure and higher than the second lower pressure; and providing means for maintaining the intermediate pressure in the intermediate space for reducing a pressure differential at the inner seal.

In another broad aspect of embodiments of the invention, apparatus for sealing a fluid at a first high pressure from a second lower pressure comprises: an inner seal capable of sealing the fluid at the first high pressure; an outer seal capable of sealing the fluid at the first high pressure, the outer seal being spaced from the inner seal for forming an intermediate space therebetween, the intermediate space having an intermediate pressure being lower than the first high pressure and higher than the second lower pressure; and means for maintaining the intermediate pressure in the intermediate space for reducing a pressure differential at the inner seal.

Further, in another broad aspect of embodiments of the invention a system adapted for sealing a boss in a high pressure cylinder and for indicating the integrity of said sealing comprises: an insert adapted to fit within the boss; an inner seal, adapted to be positioned between the insert and the boss, and capable of sealing the fluid at the first high pressure; an outer seal, adapted to be positioned between the insert and the boss, and capable of sealing the fluid at the first high pressure, the outer seal being spaced from the inner seal for forming an intermediate space therebetween, the intermediate space having an intermediate pressure being lower than the first high pressure and higher than the second lower pressure; means for maintaining the intermediate pressure in the intermediate space for reducing a pressure differential at the inner seal; and means for monitoring the intermediate pressure fluidly connected to the intermediate space for detecting a change in the intermediate pressure being indicative of a lack of integrity of the inner seal, the outer seal or both.

Preferably the intermediate pressure is maintained by balancing an inflow and outflow from the intermediate space, typically as a result of permeation across and around the inner and outer seals. Permeation is balanced by selecting a seal material for the inner and outer seals and the differential pressure, by selecting a seal geometry for the inner and outer seals or by providing a pressure relief device fluidly connected to the intermediate space for releasing pressure therefrom.

The means for monitoring the pressure in the intermediate space may be any suitable pressure monitoring means such as a pressure switch or a mechanical pressure gauge fluidly connected to the intermediate space.

### BRIEF DESCRIPTION OF THE DRAWINGS

FIG. 1 is a partial sectional view of an embodiment of the present invention illustrating an inner seal and an outer seal between an insert and a cylinder boss and having an optional monitoring port for determining integrity of the seals;

FIGS. 2a-2c are dimensional sectional views according to FIG. 1 illustrating machining of the cylinder boss to accommodate an insert using the sealing system of an embodiment of the present invention and more particularly,

FIG. 2a is a section view of the cylinder boss;

FIG. 2b is a detailed section view of an outer valve seat; and

FIG. 2c is a detailed view of a taper or chamfer adjacent an inner sealing surface to permit insertion of the insert into sealing engagement with the cylinder boss; and

FIGS. 3a-3c illustrate a plug insert adapted for insertion into the cylinder boss according to FIGS. 2a-2c and more particularly,

FIG. 3a is a side view of the plug insert;

FIG. 3b is a detailed sectional view of an annular groove adjacent a bottom end of the plug insert for accommodating the inner seal and a backup-ring;

FIG. 3c is a plan view of a top of the plug insert;

FIG. 3d is a partial sectional view of an insert illustrating parameters for calculation of a barrier thickness;

FIG. 4 is a schematic illustrating the relationship between permeation and differential pressure between inner and outer seals; and

FIG. 5 is a schematic illustrating a sectional view of an insert according to an embodiment of the invention and pressures at and between seals between the insert and a structure containing a fluid at a high pressure.

### DETAILED DESCRIPTION OF THE PREFERRED EMBODIMENT

Embodiments of the invention are described herein in the context of high pressure cylinders used to fuel vehicles. One of skill in the art would understand that the sealing arrangement described herein is applicable to any situation wherein gases are stored in vessels at high pressure.

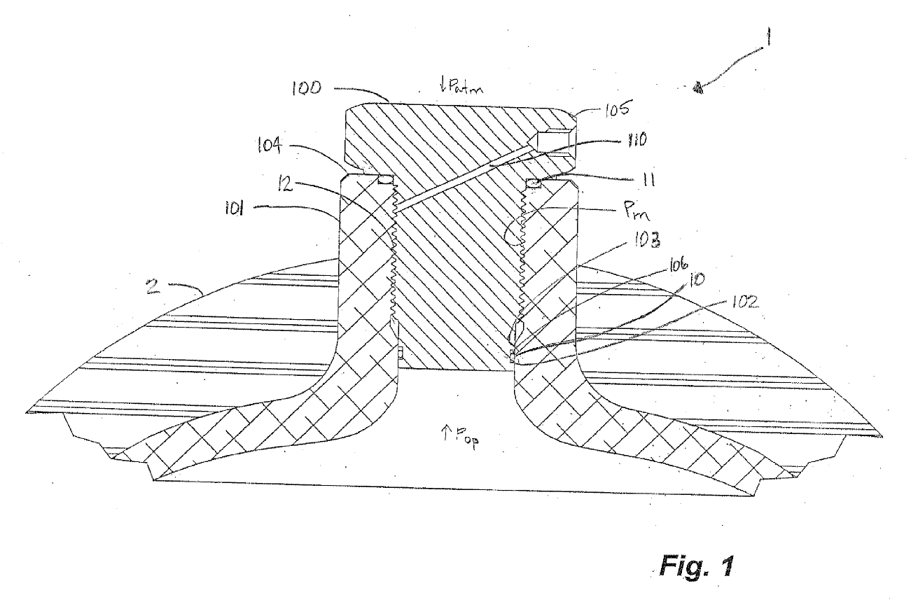

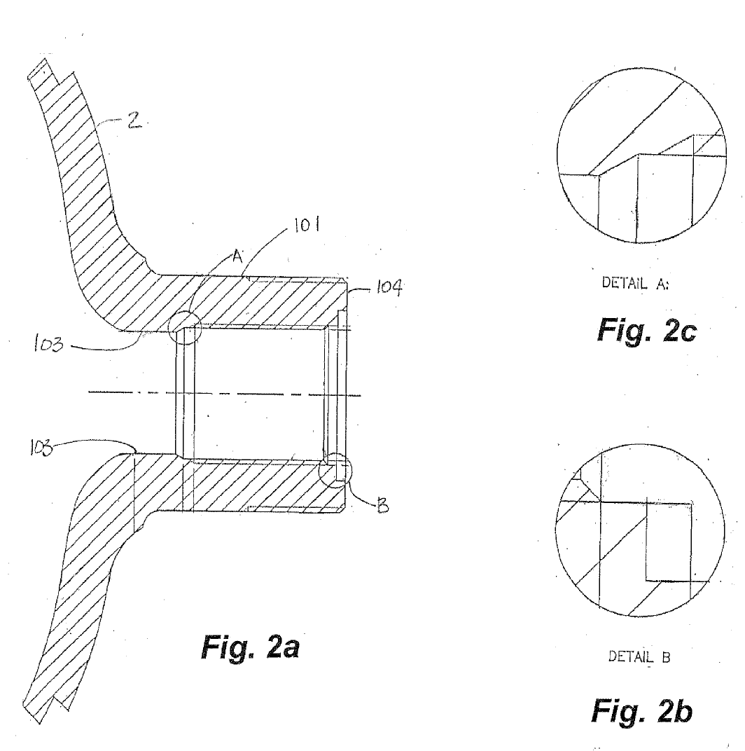

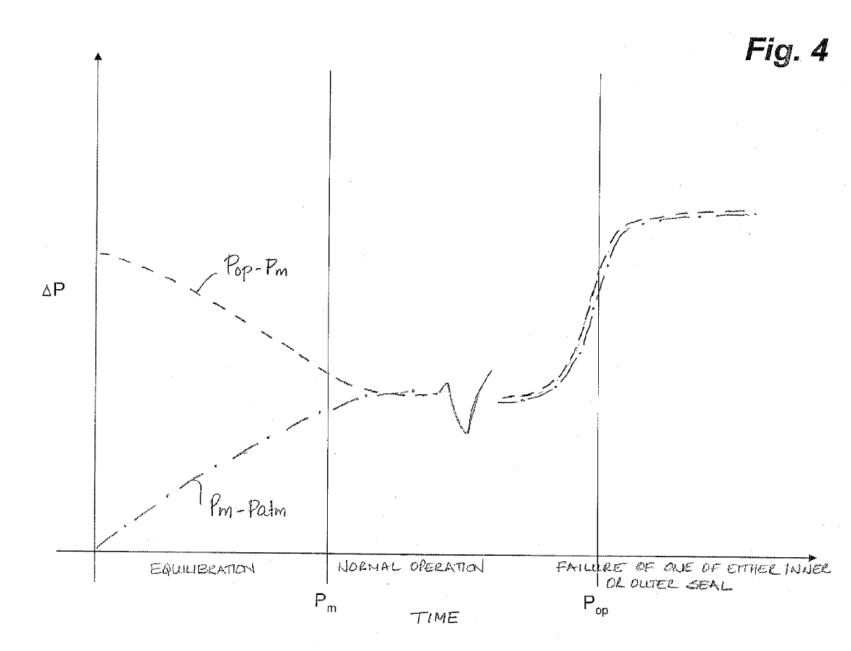

Having reference to FIGS. 1-5, a system 1 for reliably sealing a high pressure cylinder 2 is shown. The system 1 comprises an inner seal 10, exposed to a first high pressure Pₒₚ and an outer seal 11, exposed to a second lower pressure, such as atmospheric pressure Pₐₜₘ, each seal 10,11 being capable of containing the desired operating pressure or first high pressure Pₒₚ of the cylinder 2 for a gas of interest, including, but not limited to, compressed natural gas and compressed hydrogen. While discussed herein in the context of separating a high pressure from atmospheric pressure, embodiments of the invention are applicable to any arrangement separating a high pressure from a lower pressure.

Having reference to FIGS. 1, 4 and 5, the inner and outer seals 10,11 are selected to maintain an intermediate pressure Pₘ, which is lower than the first high pressure Pₒₚ of the cylinder 2, in an intermediate space 12, between the inner and the outer seals 10,11. One effect of the intermediate pressure Pₘ is to reduce the pressure differential ΔP (Pₒₚ−Pₘ) at the inner seal 10, prolonging the life of the inner seal 10.

Seal permeability is a factor to be considered when attempting to maintain the pressure Pₘ between the inner and outer seals 10,11. Seal permeability is dependant primarily on two factors, a material from which the seal 10,11 is made and a geometry of the seal 10,11 itself. As shown in Tables A and B, reproduced in part, respectively, from Peacock, R. N. “Practical selection of elastomer materials for vacuum seals.” Journal of Vacuum Science Technology Vol. 17 No. 1 (January/February 1980):330-336 and Parker Seals, Parker O-Ring Handbook, Table 3-19, Gas Permeability Rates, Pages 3-27-3-35, Parker Hannifin Corporation, 2360 Palumbo Drive, Lexington Ky. 40509 USA, the entirety of which are incorporated herein by reference, different elastomers have different gas permeability rates for different fuel types.

TABLE A

| | Helium | Nitrogen | Oxygen | Carbon Dioxide | Water |
|---|---|---|---|---|---|
| Polymer | (K × 10⁸) | (K × 10⁸) | (K × 10⁸) | (K × 10⁸) | (K × 10⁸) |
| Fluoroelastomer | 9-16 | 0.05-0.3 | 1.0-1.1 | 5.8-6.0 | 40 |
| Buna-N | 5.2-6 | 0.2-2.0 | 0.7-6.0 | 5.7-48 | 760 |
| Buna-S | 18 | 4.8-5 | 13 | 94 | 1800 |
| Neoprene | 10-11 | 0.8-1.2 | 3-4 | 19-20 | 1400 |
| Butyl | 5.2-8 | 0.24-0.35 | 1.0-1.3 | 4-5.2 | 30-150 |
| Polyurethane | — | 0.4-1.1 | 1.1-3.6 | 10-30 | 260-9500 |
| Propyl | — | 7 | 20 | 90 | — |
| Silicone | — | — | 76-460 | 460-2300 | 8000 |
| TEFLON ™ | — | 0.14 | 0.04 | 0.12 | 27 |
| KEL-T ™ | — | 0.004-0.3 | 0.02-0.7 | 0.04-1 | — |
| Polyimide | 1.9 | 0.03 | 0.1 | 0.2 | — |

K=permeation constant in sccms⁻¹cm⁻² cmatm⁻¹

TABLE B

| | | Tem- | | |
|---|---|---|---|---|
| | | pera- | | |
| Gas or | | ture | Temper- | Permeability |
| Liquid | Elastomer | ° C. | ature ° F. | (1) |
| Acetylene | Butyl | 25 | 77 | 1.26 |
| Acetylene | Butyl | 50 | 122 | 5.74 |
| Acetylene | Natural | 25 | 77 | 74.5 |
| Acetylene | Natural | 50 | 122 | 192 |
| Acetylene | Nitrile | 25 | 77 | 18.7 |
| Acetylene | Nitrile | 50 | 122 | 67.4 |
| Hydrogen | Butadiene | 25 | 77 | 31.6 |
| Hydrogen | Butadiene | 50 | 122 | 76 |
| Hydrogen | Butyl (B0318-70) | 35 | 95 | 16.1 |
| Hydrogen | Butyl (B0318-70) | 82 | 180 | 68.2 |
| Hydrogen | Butyl (B0318-70) | 124 | 255 | 273 |
| Hydrogen | Ethylene Propylene | 38 | 100 | 28.9-111 |
| Hydrogen | Ethylene Propylene | 40 | 104 | 111 |
| Hydrogen | Ethylene Propylene | 38 | 100 | 45.3 |
| | (E0529-65) | | | |
| Hydrogen | Ethylene Propylene | 93 | 200 | 187-544 |
| | (E0529-75) | | | |
| Hydrogen | Ethylene Propylene | 94 | 202 | 544 |
| Hydrogen | Ethylene Propylene | 94 | 201 | 252 |
| | (E0529-65) | | | |
| Hydrogen | Ethylene Propylene | 152 | 306 | 599-1730 |
| | (E0529-75) | | | |
| Hydrogen | Ethylene Propylene | 155 | 311 | 1730 |
| Hydrogen | Ethylene Propylene | 151 | 304 | 591 |
| | (E0529-65) | | | |
| Hydrogen | Ethylene Propylene | 93 | 200 | 160 |
| | (E0529-75) | | | |
| Hydrogen | Fluorocarbon-Viton ™ | 38 | 100 | 180 |
| Hydrogen | Neoprene | 38 | 100 | 10.3-32.1 |
| Hydrogen | Nitrile | 39 | 103 | 11.9 |
| Hydrogen | Niltrile (N0741-75) | 79 | 175 | 47.0-125 |
| Hydrogen | Nitrile | 80 | 176 | 88.2 |
| Hydrogen | Niltrile (N0741-75) | 121 | 250 | 98.8-330 |
| Hydrogen | Polyacrylate (A0607-70) | 38 | 100 | 49.6 |
| Hydrogen | Polyacrylate (A0607-70) | 91 | 195 | 174 |
| Hydrogen | Polyacrylate (A0607-70) | 153 | 307 | 927 |
| Hydrogen | Polysulfide | 25 | 77 | 102 |
| Hydrogen | Polyurethane (P0642- | 39 | 103 | 19.3 |
| | 70) | | | |
| Hydrogen | Polyurethane (P0642- | 39 | 102 | 4.89 |
| | 90) | | | |
| Hydrogen | Polyurethane (P0642- | 66 | 151 | 70.4 |
| | 70) | | | |
| Hydrogen | Polyurethane (P0642- | 67 | 152 | 21.3 |
| | 90) | | | |
| Hydrogen | Polyurethane (P0642- | 94 | 202 | 155 |
| | 70) | | | |
| Hydrogen | SBR | 25 | 77 | 30.1 |
| Hydrogen | SBR (G0244-70) | 38 | 101 | 46.2 |
| Hydrogen | SBR (G0244-70) | 84 | 183 | 245 |
| Hydrogen | SBR (G0244-70) | 122 | 251 | 539 |
| Hydrogen | Silicone | Room | | 1880-488 |
| Hydrogen | Silicone | 25 | 77 | 495 |
| Hydrogen | Silicone (S0684-70) | 39 | 103 | 1010 |
| Hydrogen | Silicone | 93 | 200 | 1570-2070 |
| Hydrogen | Silicone (S0684-70) | 91 | 195 | 2070 |
| Hydrogen | Silicone | 149 | 300 | 3300-8760 |
| Hydrogen | Silicone (S0684-70) | 156 | 313 | 4300 |
| Hydrogen | FEP PTFE | −74 | −101 | .0113 |
| Hydrogen | FEP PTFE | −46 | −51 | .180 |
| Hydrogen | FEP PTFE | −18 | 0 | 1.05 |
| Hydrogen | FEP PTFE | 10 | 50 | 3.90 |
| Hydrogen | FEP PTFE | 25 | 77 | 9.89 |
| Hydrogen | FEP PTFE | 38 | 100 | 10.1 |
| Hydrogen | FEP PTFE | 50 | 122 | 24.7 |
| Hydrogen | FEP PTFE | 66 | 151 | 22.5 |
| Hydrogen | FEP PTFE | 75 | 167 | 49.5 |
| Hydrogen | FEP PTFE | 100 | 212 | 89.9 |
| Hydrogen | FEP PTFE | 25 | 77 | 17.8 |
| Hydrogen | FEP PTFE | 30 | 86 | 42.0 |
| Hydrogen | FEP PTFE | 50 | 122 | 63.8 |
| Methane | Butadiene | 25 | 77 | 9.77 |
| Methane | Butyl | 25 | 77 | .56 |
| Methane | Fluorocarbon | 30 | 86 | .12 |
| Methane | Natural | 25 | 77 | 22.7 |
| Methane | Neoprene | 25 | 77 | 2.6 |
| Methane | Nitrile | 25 | 77 | 2.4 |
| Methane | Silicone | 25 | 77 | 705 |
| Methane | Silicone | 30 | 86 | 443 |
| Methane | FEP PTFE | 25 | 77 | .702-.83 |
| Methane | FEP PTFE | 30 | 86 | 1.05 |
| Methane | FEP PTFE | 50 | 122 | 2.02 |
| Methane | FEP PTFE | 75 | 167 | 4.50 |
| Methane | FEP PTFE | 100 | 212 | 8.99 |
| Methane | FEP PTFE | 30 | 86 | 1.13 |
| Methane | FEP PTFE | 50 | 122 | 3.0 |
| Propane | Butadiene | 25 | 77 | 22-40.5 |
| Propane | Butyl | 25 | 77 | 1.28 |
| Propane | Natural | 25 | 77 | 126 |
| Propane | Neoprene | 25 | 77 | 5.4 |
| Propane | Polysulfide | 25 | 77 | 1.09 |
| Propane | Silicone | 25 | 77 | 3080 |

Std cc cm/cm²sec.bar

Further, as demonstrated in the following formulas, permeation can be calculated dependant upon the material selected or upon the geometry or size of the barrier presented by the seal 10, 11, for a particular material. Permeation is defined as the passage of a gas under pressure into, through and out a solid material by diffusion and solution to the low pressure side. Assuming an equilibrium state, the rate of gas permeation can be calculated using the following formula:

$$Q = KA \frac{( {P}_{1} - {P}_{2} )}{d}$$

where,
K=permeation constant

$$[ \frac{{cm}^{3} \cdot cm}{s \cdot {cm}^{2} \cdot atm} ]$$
A=area of the barrier [cm³]
P₁=high side pressure [atm]
P₂=low side pressure [atm]
d=barrier thickness [cm]

For example, if the gas to be contained is helium, the permeation rate from a 2.000″ port, on a 350 bar cylinder using a nitrile (Buna-N) seal, can be estimated using the following values in the above equation:

The average permeation constant for helium gas through nitrile (Buna-N):

$$K = 5.6 \times {10}^{- 8} [ \frac{{cm}^{3} \cdot cm}{s \cdot {cm}^{2} \cdot atm} ]$$

The area of the barrier:
A=π·D·t=π·5.44·0.27=4.6 cm²

The high and low side pressures:
P₁=345 atm
P₂₌₁ atm

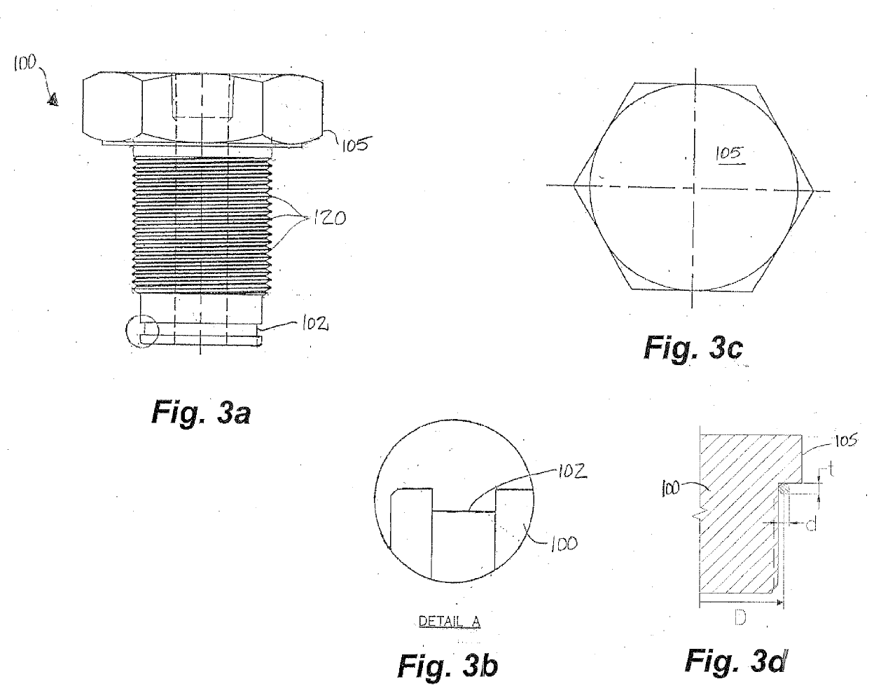

The barrier thickness, as shown in FIG. 3d:
d=0.36 cm

Substituting the above values into the permeation rate equation yields:

$$Q = 5.6 \times {10}^{- 8} [ \frac{{cm}^{3} \cdot cm}{s \cdot {cm}^{2} \cdot atm} ] \cdot \frac{4.6 {cm}^{2} ( 345 - 1 ) atm}{0.36 cm} \\ = 2.46 \times {10}^{- 4} \frac{{cm}^{3}}{s} = 0.88 \frac{{cm}^{3}}{hr}$$

In a preferred embodiment of the invention, for use in a 700 bar (10,000 psi) cylinder 2, the inner and outer seals 10,11 are selected or configured to maintain a maximum intermediate pressure Pₘ of 350 bar (5000 psi) in the intermediate space 12 therebetween, thus significantly reducing the pressure differential ΔP at the inner seal 10. Each of the seals 10,11 is selected to be capable of containing the full operating pressure or first high pressure Pₒₚ of 700 bar (10,000 psi) so that in the event of a failure of the inner seal 10, the contents of the cylinder 2 are not vented to atmosphere. The inner and outer seals 10,11 however, are selected so that the permeation across the inner seal 10 is compensated for or balanced by the permeation at the outer seal 11, effectively maintaining the lower intermediate pressure Pₘ therebetween.

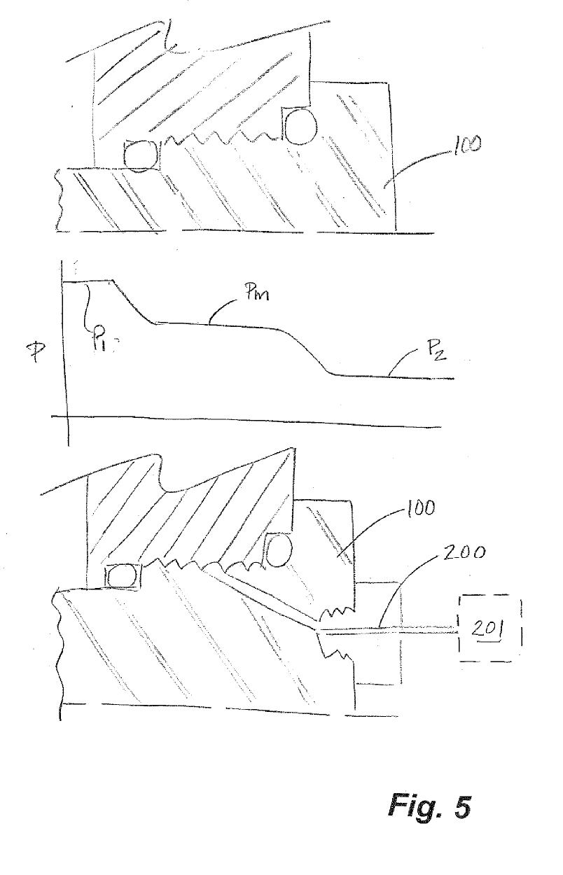

Optionally, as shown in FIG. 5, a small orifice 200 may be provided from the intermediate space 12 to atmosphere and possibly fit with a pressure relief device 201 to permit a controlled release of pressure between the seals 10,11 to maintain the desired intermediate pressure Pₘ therebetween.

As shown in FIGS. 1, 2a-2c and 3a-3c, typically, the inner seal is a circumferential seal 10, the circumferential seal 10 positioned for sealing between an insert 100, threaded into a boss 101 of the cylinder 2, and the boss 101. Preferably, the circumferential seal 10 is fit within an annular groove 102 in the insert 100 for sealing against a finished sealing surface 103 of the cylinder boss 101. The cylinder boss 101 is machined to provide the suitable sealing surface 103 to prevent any leaking due to poor sealing therebetween. The outer seal 111 is spaced from the inner seal 10 and is preferably a compression seal 11 in sealing arrangement between an end 104 of the boss 101 and a top 105 of the insert, 100. Configuration of the seals 10,11 is not critical to embodiments of the invention disclosed herein and therefore both inner and outer seals 10,11 may be circumferential seals, compressions seals or the like.

Preferably, a backup ring 106 is positioned adjacent the inner seal 10 and in the annular groove 102. The backup ring 106 is typically manufactured from a material, such as nitrile, having a greater durometer rating than the inner seal 10 so as to provide a surface against which the seal 10 may be compressed and to prevent extrusion of the seal 10 from the annular groove 102. The backup ring 106 may be a split ring or a deformable ring.

In the preferred embodiment, as shown in FIG. 1, a monitoring port 110 is provided having access and being fluidly connected to the intermediate space 12 between the seals 10,11. The monitoring port 110 is used to house instrumentation for monitoring the integrity of the inner and outer seals 10,11. Advantageously, due to the intermediate pressure Pₘ between the inner and outer seals 10,11 being maintained at a pressure lower than the first high pressure Pₒₚ in the cylinder 2, should the inner seal 10 leak or fail completely, the intermediate pressure Pₘ between the inner and the outer seals 10,11 will exhibit a measurable change in pressure and rise to be in equilibrium with the first high pressure POP inside the cylinder 2, the rise being detectable at the monitoring port 110. Preferably, means for monitoring the pressure (not shown), such as a pressure switch, a mechanical pressure gauge or other pressure indicator is fluidly connected to the monitoring port 110 for continually monitoring the intermediate pressure Pₘ between the inner and outer seals 10,11.

Further, if for some reason the outer seal 11 should fail, rather than the inner seal 10, the change or drop in the intermediate pressure Pₘ would be observed and signal a need for service. In both cases, the redundancy in the sealing arrangement would allow the cylinder 2, and ultimately, a vehicle, (not shown) to which the cylinder 2 is supplying fuel, to remain in use until it could be removed from service and the inner and outer seals 10,11 replaced.

Optionally, additional apparatus (not shown) such as a burst disc, an on-off valve, gas sensors, flow restrictors or regulators, pressure regulators, check valves or gas filters, may be fit within the monitoring port 110.

In one embodiment of the invention, wherein the insert 100 and the cylinder boss 101 are manufactured using aluminum, threads 120 used for threading the insert 100 into the boss 101 are not self-centering to avoid sharp edges which may result in the insert 100 galling to the boss 101 during installation or removal. Further, the sealing surface 103 is polished to remove any spiral or radial tool marks, scratches or gouges which would impair sealing thereto.

An additional advantage of positioning the inner seal 10 into the boss 101 of the cylinder 2 is realized during manufacturing high pressure cylinders 2 which undergo autofrettage as part of the manufacturing process. Autofrettage pressures have the potential to cause deformation of the boss 101 of the cylinder 2, thus, positioning a seal 10 at an inner surface adjacent the containment portion of the cylinder 2 acts to protect the boss 101 from the high pressure Pₒₚ, preventing costly rework of the boss 101 or rendering the cylinder 2 defective.

1. A method for sealing a fluid at a first high pressure from a second lower pressure comprising:
providing an inner seal capable of sealing the fluid at the first high pressure from the second lower pressure;
providing an outer seal also capable of sealing the fluid at the first high pressure from the second lower pressure, the outer seal being spaced from the inner seal for forming an intermediate space therebetween; and
maintaining an intermediate pressure in the intermediate space, the intermediate pressure being lower than the first high pressure and higher than the second lower pressure the intermediate pressure in the intermediate space for reducing a pressure differential at the inner seal.

2. The method as described in claim 1 wherein maintaining the intermediate pressure comprises balancing an inflow into and an outflow of fluid from the intermediate space.

3. The method as described in claim 2, wherein the inflow into and the outflow from the intermediate space is as a result of permeation across the inner and outer seals, further comprising:
selecting an inner seal of a material having a first permeation rate at a pressure differential between the high pressure and the intermediate pressure; and
selecting an outer seal of a material having a second permeation rate at a pressure differential between the intermediate pressure and the lower pressure,
wherein the first and second permeation rates are balanced for maintaining the intermediate pressure.

4. The method as described in claim 2, wherein the inflow into and the outflow from the intermediate space is as a result of permeation across the inner and outer seals, further comprising:
selecting an inner seal having a geometry resulting in a first permeation rate at a pressure differential between the high pressure and the intermediate pressure; and
selecting an outer seal having a geometry resulting in a second permeation rate at a pressure differential between the intermediate pressure and the lower pressure,
wherein the first and second permeation rates are balanced for maintaining the intermediate pressure.

5. The method as described in claim 2, wherein the inflow into and the outflow from the intermediate space is as a result of permeation across the inner and outer seals, further comprising:
selecting an inner seal having a material and a geometry resulting in a first permeation rate at a pressure differential between the high pressure and the intermediate pressure; and
selecting an outer seal having a material and a geometry resulting in a second permeation rate at a pressure differential between the intermediate pressure and the lower pressure,
wherein the first and second permeation rates are balanced for maintaining the intermediate pressure.

6. The method as described in claim 1 further comprising:
monitoring the intermediate pressure in the intermediate space; and
detecting a change in the intermediate pressure being indicative of a lack of integrity of the inner seal, the outer seal or both.

7. The method as described in claim 2 wherein maintaining the intermediate pressure comprises permitting a controlled release of pressure from the intermediate space to balance permeation across the inner seal.

8. The method as described in claim 7 further comprising fluidly connecting a pressure relief device to the intermediate space for permitting the controlled release of pressure from the intermediate space to balance permeation across the inner seal.

9. Apparatus for sealing a fluid at a first high pressure from a second lower pressure comprising:
an inner seal capable of sealing the fluid at the first high pressure;
an outer seal capable of sealing the fluid at the first high pressure, the outer seal being spaced from the inner seal for forming an intermediate space therebetween, the intermediate space having an intermediate pressure being lower than the first high pressure and higher than the second lower pressure; and
means for maintaining the intermediate pressure in the intermediate space for reducing a pressure differential at the inner seal.

10. The apparatus as described in claim 9 wherein the means for maintaining the intermediate pressure balances an inflow and an outflow from the intermediate space.

11. The apparatus as described in claim 10 wherein the inflow and outflow from the intermediate space is as a result of permeation across the inner and outer seals, further comprising:
an inner seal material having a first permeation rate at a pressure differential between the high pressure and the intermediate pressure; and
an outer seal material having a second permeation rate at a pressure differential between the intermediate pressure and the lower pressure,
wherein the first and second permeation rates are balanced for maintaining the intermediate pressure.

12. The apparatus as described in claim 10 further comprising:
an inner seal material and geometry resulting in a first permeation rate at a pressure differential between the high pressure and the intermediate pressure; and
an outer seal material and geometry resulting in a second permeation rate at a pressure differential between the intermediate pressure and the lower pressure,
wherein the first and second permeation rates are balanced for maintaining the intermediate pressure.

13. The apparatus as described in claim 10 further comprising:
an inner seal geometry resulting in a first permeation rate at a pressure differential between the high pressure and the intermediate pressure; and
an outer seal geometry resulting in a second permeation rate at a pressure differential between the intermediate pressure and the lower pressure,
wherein the first and second permeation rates are balanced for maintaining the intermediate pressure.

14. The apparatus as described in claim 9 further comprising:
means for monitoring the intermediate pressure fluidly connected to the intermediate space for detecting a change in the intermediate pressure being indicative of a lack of integrity of the inner seal, the outer seal or both.

15. The apparatus as described in claim 10 wherein the means for maintaining the intermediate pressure is a pressure relief device fluidly connected to the intermediate space for permitting a controlled release of pressure therefrom to balance permeation across the inner seal.

16. The apparatus as described in claim 14 wherein the means for monitoring the intermediate pressure in the intermediate space is a pressure switch.

17. The apparatus as described in claim 14 wherein the means for monitoring the intermediate pressure in the intermediate space is a mechanical pressure gauge.

18. The apparatus as described in claim 9 wherein the inner and outer seals are adapted to seal an opening in a structure housing the first high pressure.

19. The apparatus as described in claim 18 further comprising:
an insert adapted to be fit within the opening in the structure, wherein
the inner and outer seals seal between the insert and the structure.

20. The apparatus as described in claim 19 wherein,
the inner seal is a circumferential seal adapted to fit within an annular groove in the insert; and
the outer seal is a compression seal adapted for positioning in sealing arrangement between the insert and the structure.

21. The apparatus as described in claim 20 wherein the structure is a high pressure cylinder having a cylinder boss wherein,
the inner seal is a circumferential seal adapted to fit within an annular groove in the insert; and
the outer seal is a compression seal adapted for positioning in sealing arrangement between the insert and a top of the cylinder boss.

22. The apparatus as described in claim 21 further comprising a backup ring adapted to fit within the annular groove adjacent the inner seal for supporting the inner seal for compression thereagainst and for preventing extrusion from the annular groove.

23. The apparatus as described in claim 18 wherein the means for monitoring the intermediate pressure is adapted to be fluidly connected to the intermediate space through a monitoring port formed in the structure.

24. A system adapted for sealing a boss in a high pressure cylinder and for indicating the integrity of said sealing comprising:
an insert adapted to fit within the boss;
an inner seal, adapted to be positioned between the insert and the boss, and capable of sealing the fluid at the first high pressure;
an outer seal, adapted to be positioned between the insert and the boss, and capable of sealing the fluid at the first high pressure, the outer seal being spaced from the inner seal for forming an intermediate space therebetween, the intermediate space having an intermediate pressure being lower than the first high pressure and higher than the second lower pressure;
means for maintaining the intermediate pressure in the intermediate space for reducing a pressure differential at the inner seal; and
means for monitoring the intermediate pressure fluidly connected to the intermediate space for detecting a change in the intermediate pressure being indicative of a lack of integrity of the inner seal, the outer seal or both.

25. The system as described in claim 24 wherein the means for maintaining the intermediate pressure balances an inflow and an outflow from the intermediate space.

26. The system as described in claim 25 wherein the inflow and outflow from the intermediate space is as a result of permeation across the inner and outer seals, further comprising:
an inner seal material having a first permeation rate at a pressure differential between the high pressure and the intermediate pressure; and
an outer seal material having a second permeation rate at a pressure differential between the intermediate pressure and the lower pressure,
wherein the first and second permeation rates are balanced for maintaining the intermediate pressure.

27. The system as described in claim 25 further comprising:
an inner seal geometry resulting in a first permeation rate at a pressure differential between the high pressure and the intermediate pressure; and
an outer seal geometry resulting in a second permeation rate at a pressure differential between the intermediate pressure and the lower pressure,
wherein the first and second permeation rates are balanced for maintaining the intermediate pressure.

28. The system as described in claim 25 further comprising:
an inner seal material and geometry resulting in a first permeation rate at a pressure differential between the high pressure and the intermediate pressure; and
an outer seal material and geometry resulting in a second permeation rate at a pressure differential between the intermediate pressure and the lower pressure,
wherein the first and second permeation rates are balanced for maintaining the intermediate pressure.

29. The system as described in claim 24 wherein the means for maintaining the intermediate pressure is a pressure relief device fluidly connected to the intermediate space for permitting a controlled release of pressure therefrom to balance permeation across the inner seal.

30. The system as described in claim 24 wherein the means for monitoring the intermediate pressure in the intermediate space is a pressure switch.

31. The system as described in claim 24 wherein the means for monitoring the intermediate pressure in the intermediate space is a mechanical pressure gauge.
